(19) United States
(12) Patent Application Publication
(10) Pub. No.: US 2025/0056583 A1
(43) Pub. Date: Feb. 13, 2025

(54) RADAR TRANSMISSIONS USING RESOURCES OF SIDELINK RESOURCE SUB-POOLS

(71) Applicant: QUALCOMM Incorporated, San Diego, CA (US)

(72) Inventors: Stelios STEFANATOS, San Diego, CA (US); Shailesh PATIL, San Diego, CA (US); Anshuman SAXENA, San Diego, CA (US); Ahmed Kamel SADEK, San Diego, CA (US); Kapil GULATI, Belle Mead, NJ (US)

(21) Appl. No.: 18/714,837

(22) PCT Filed: Jan. 30, 2023
(86) PCT No.: PCT/US2023/061566

§ 371 Date: May 30, 2024

(30) Foreign Application Priority Data
Feb. 28, 2022 (GR) 20220100180

(51) Int. Cl. H04W 72/40; H04L 5/00; H04W 92/18

(52) U.S. Cl. CPC H04W 72/40; H04L 5/0092; H04W 92/18

(57) ABSTRACT

Various aspects of the present disclosure generally relate to wireless communication. In some aspects, a user equipment (UE) may receive, from a network entity, a sidelink resource sub-pool configuration that indicates a partition of a sidelink resource pool into a first sidelink resource sub-pool associated with radar transmissions and a second sidelink resource sub-pool associated with sidelink transmissions. The UE may transmit a radar transmission using resources of the first sidelink resource sub-pool based at least in part on the sidelink resource sub-pool configuration. Numerous other aspects are described.

### CROSS-REFERENCE TO RELATED APPLICATION

This patent application claims priority to Greece Nonprovisional Patent Application No. 20220100180, filed on Feb. 28, 2022, entitled “RADAR TRANSMISSIONS USING RESOURCES OF SIDELINK RESOURCE SUB-POOLS,” which is hereby expressly incorporated by reference herein.

### FIELD OF THE DISCLOSURE

Aspects of the present disclosure generally relate to wireless communication and to techniques and apparatuses for radar transmissions using resources of sidelink resource sub-pools.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network entity, a sidelink resource sub-pool configuration that indicates a partition of a sidelink resource pool into a first sidelink resource sub-pool associated with radar transmissions and a second sidelink resource sub-pool associated with sidelink transmissions; and transmit a radar transmission using resources of the first sidelink resource sub-pool based at least in part on the sidelink resource sub-pool configuration.

In some implementations, an apparatus for wireless communication at a network entity includes a memory and one or more processors, coupled to the memory, configured to: transmit, to a UE, a sidelink resource sub-pool configuration that indicates a partition of a sidelink resource pool into a first sidelink resource sub-pool associated with radar transmissions and a second sidelink resource sub-pool associated with sidelink transmissions.

In some implementations, a method of wireless communication performed by a UE includes receiving, from a network entity, a sidelink resource sub-pool configuration that indicates a partition of a sidelink resource pool into a first sidelink resource sub-pool associated with radar transmissions and a second sidelink resource sub-pool associated with sidelink transmissions; and transmitting a radar transmission using resources of the first sidelink resource sub-pool based at least in part on the sidelink resource sub-pool configuration.

In some implementations, a method of wireless communication performed by a network entity includes transmitting, to a UE, a sidelink resource sub-pool configuration that indicates a partition of a sidelink resource pool into a first sidelink resource sub-pool associated with radar transmissions and a second sidelink resource sub-pool associated with sidelink transmissions.

In some implementations, a non-transitory computer-readable medium storing a set of instructions for wireless communication includes one or more instructions that, when executed by one or more processors of a UE, cause the UE to: receive, from a network entity, a sidelink resource sub-pool configuration that indicates a partition of a sidelink resource pool into a first sidelink resource sub-pool associated with radar transmissions and a second sidelink resource sub-pool associated with sidelink transmissions; and transmit a radar transmission using resources of the first sidelink resource sub-pool based at least in part on the sidelink resource sub-pool configuration.

In some implementations, a non-transitory computer-readable medium storing a set of instructions for wireless communication includes one or more instructions that, when executed by one or more processors of a network entity, cause the network entity to: transmit, to a UE, a sidelink resource sub-pool configuration that indicates a partition of a sidelink resource pool into a first sidelink resource sub-pool associated with radar transmissions and a second sidelink resource sub-pool associated with sidelink transmissions.

In some implementations, an apparatus for wireless communication includes means for receiving, from a network entity, a sidelink resource sub-pool configuration that indicates a partition of a sidelink resource pool into a first sidelink resource sub-pool associated with radar transmissions and a second sidelink resource sub-pool associated with sidelink transmissions; and means for transmitting a radar transmission using resources of the first sidelink resource sub-pool based at least in part on the sidelink resource sub-pool configuration.

In some implementations, an apparatus for wireless communication includes means for transmitting, to a UE, a sidelink resource sub-pool configuration that indicates a partition of a sidelink resource pool into a first sidelink resource sub-pool associated with radar transmissions and a second sidelink resource sub-pool associated with sidelink transmissions.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of communication and radar transmissions in sidelink resources, in accordance with the present disclosure.

FIGS. 5-7 are diagrams illustrating examples associated with radar transmissions using resources of sidelink resource sub-pools, in accordance with the present disclosure.

FIGS. 8-9 are diagrams illustrating example processes associated with radar transmissions using resources of sidelink resource sub-pools, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

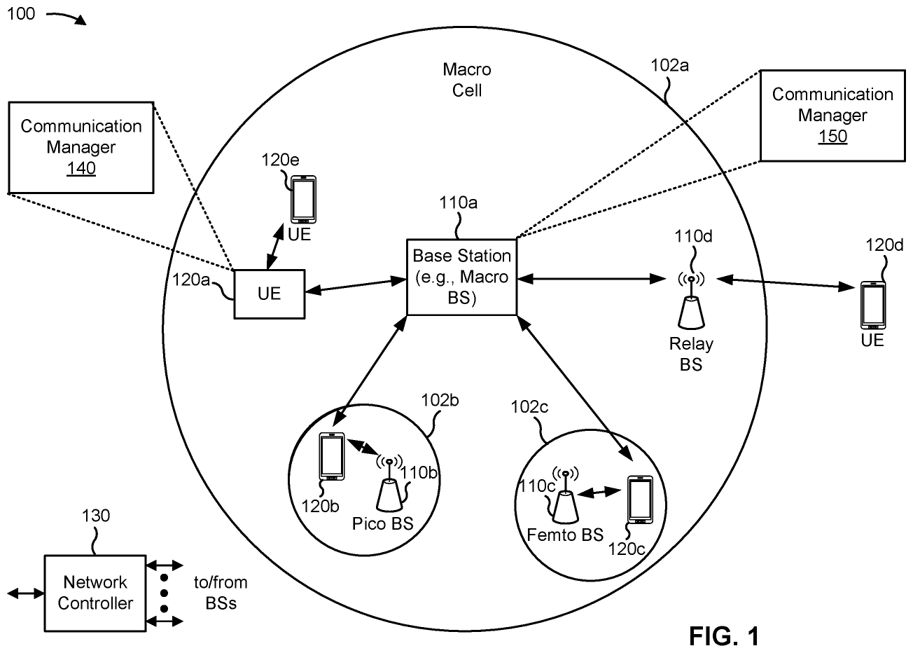

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network entity, a sidelink resource sub-pool configuration that indicates a partition of a sidelink resource pool into a first sidelink resource sub-pool associated with radar transmissions and a second sidelink resource sub-pool associated with sidelink transmissions; and transmit a radar transmission using resources of the first sidelink resource sub-pool based at least in part on the sidelink resource sub-pool configuration. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit, to a UE, a sidelink resource sub-pool configuration that indicates a partition of a sidelink resource pool into a first sidelink resource sub-pool associated with radar transmissions and a second sidelink resource sub-pool associated with sidelink transmissions. Additionally, or alternatively, the communication manager 150 may perform one or more other operations described herein.

As indicated above, FIG. 1 is provided as an example. Other examples may differ from what is described with regard to FIG. 1.

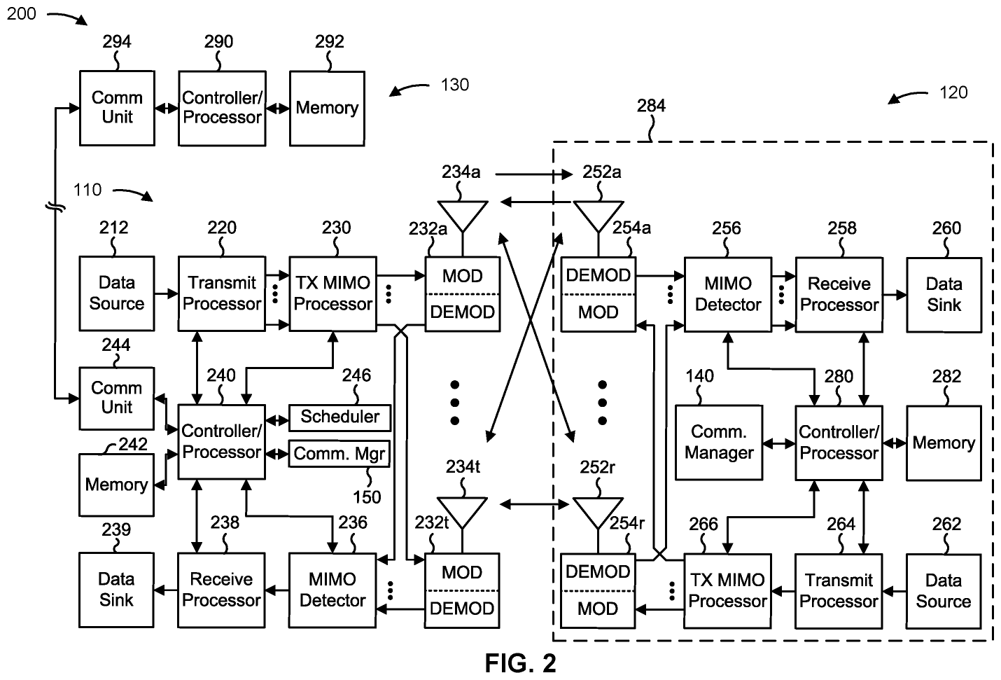

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

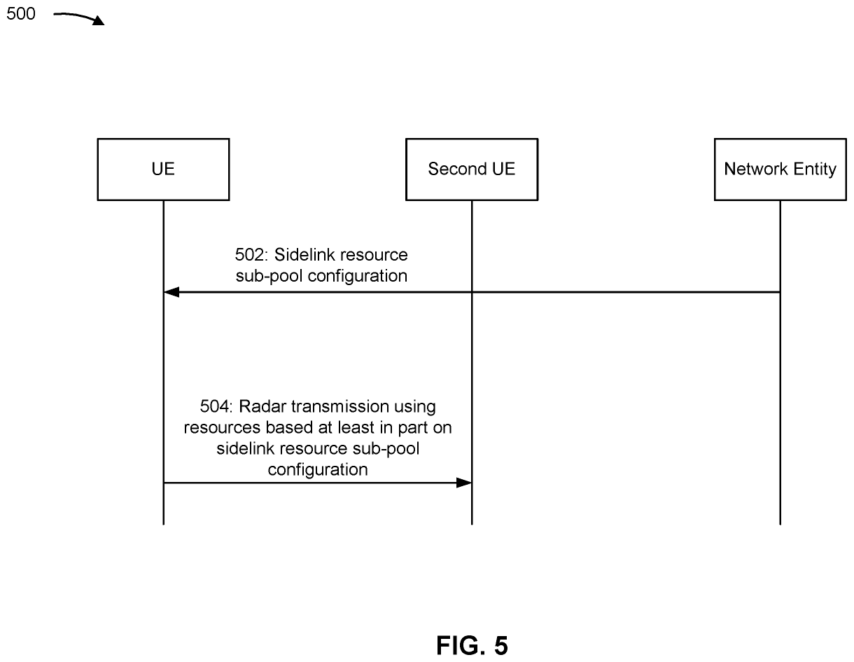

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

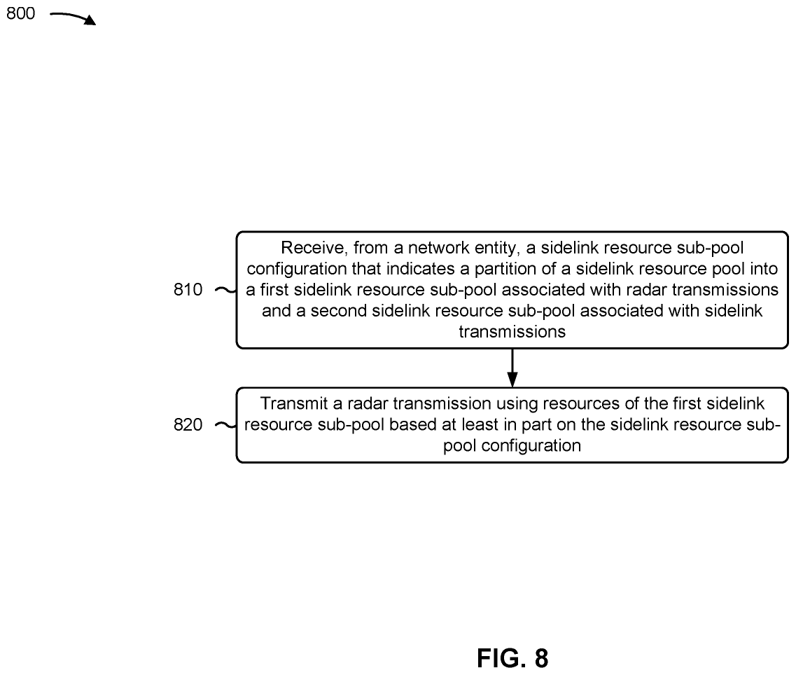

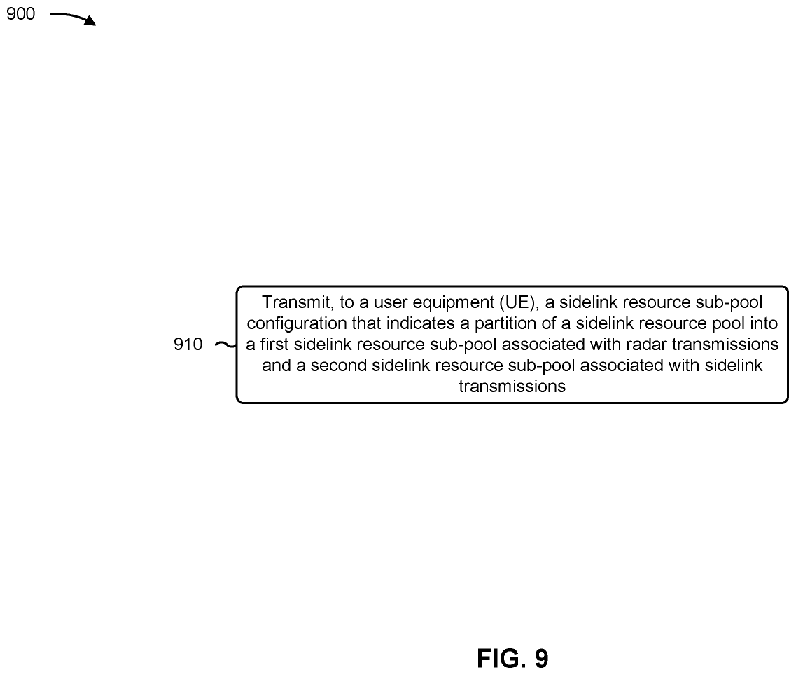

The controller/processor 240 of the base station 110, the controller/processor 280 of the UE 120, and/or any other component(s) of FIG. 2 may perform one or more techniques associated with radar transmissions using resources of sidelink resource sub-pools, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network entity, a sidelink resource sub-pool configuration that indicates a partition of a sidelink resource pool into a first sidelink resource sub-pool associated with radar transmissions and a second sidelink resource sub-pool associated with sidelink transmissions; and/or means for transmitting a radar transmission using resources of the first sidelink resource sub-pool based at least in part on the sidelink resource sub-pool configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting, to a UE, a sidelink resource sub-pool configuration that indicates a partition of a sidelink resource pool into a first sidelink resource sub-pool associated with radar transmissions and a second sidelink resource sub-pool associated with sidelink transmissions. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

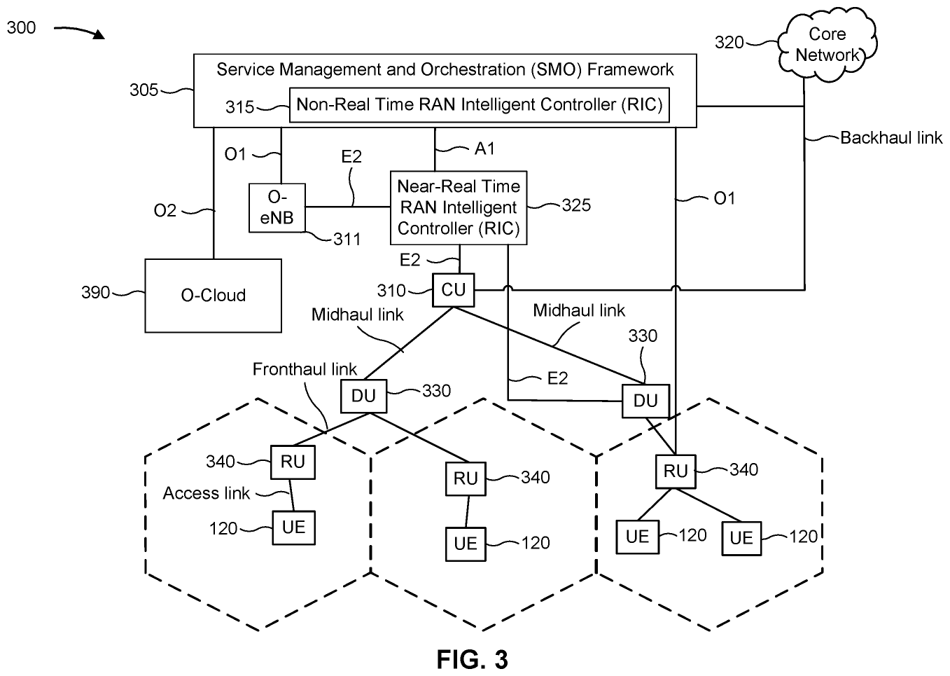

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an JAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit—User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as AI policies).

As indicated above, FIG. 3 is provided as an example. Other examples may differ from what is described with regard to FIG. 3.

Joint communication and radar/sensing operations may be used in wireless communication systems. For joint communication and radar/sensing operations, sidelink transmissions may be performed over same resources as radar transmissions, for example, in automotive applications. Sensing may be associated with “sensing as a service” or “sensing-assisted communications.” In “sensing as a service,” a user (or application) may obtain sensing information on-demand using the same UE as for communications. In “sensing-assisted communications,” sensing may be performed for the purpose of improving communication procedures and efficiency, e.g., for beam selection.

Joint communication and radar/sensing operations may involve a UE performing both sidelink communication (e.g., cellular V2X (CV2X) communication) and radar/sensing tasks over the same time-frequency resources (or band) to achieve improved spectral efficiency and to reduce implementation complexity. A band (e.g., a licensed band), which may originally be reserved and used for communication purposes only, may also be used for radar transmissions.

Joint communication and radar/sensing operations may be based at least in part on OFDM waveforms being suitable to serve as radar probing signals, especially for numerologies with a relatively small subcarrier spacing. With OFDM as a sensing (or probing) waveform, NR PHY design/procedures may accommodate sensing transmissions by treating the sensing transmissions as additional traffic. From a PHY (Layer 1) perspective, radar transmissions may be “transparent,” as the radar transmissions may be treated (and transmitted) the same as conventional data. Upper layers (e.g., a medium access control (MAC) layer) may be aware of radar transmissions and handle various aspects such as quality of service (QoS).

With respect to various resource requirements of radar (or sensing) transmissions, radar transmissions may be associated with various characteristics in terms of time-frequency utilization toward achieving performance indicators relevant to sensing applications (e.g., maximum detection range, and/or detection/tracking accuracy). A first characteristic may be a relatively high bandwidth utilization, which may achieve a high (e.g., sub-meter) range resolution. Depending on the application, a radar transmission may occupy anything from a few hundred MHz of bandwidth up to a few GHz of bandwidth. A second characteristic may be a relatively large time duration, which may increase a processing gain (e.g., when a transmission power and beamforming gain are not sufficient to detect targets at a given maximum range of interest) and detect a Doppler frequency (e.g., which may provide velocity information for detected targets). A typical radar transmission burst (or a coherent processing interval) may be of the order of a few milliseconds. An NR waveform being used as a probing signal may correspond to multiple back-to-back slots (and all associated OFDM symbols) being utilized. A third characteristic may be a transmit periodicity of the order of tens to a few hundreds of milliseconds. Depending on the application, more or less frequent transmissions may be needed to keep track of environment dynamics. Further, within an NR framework, the various resource requirements of radar (or sensing) transmissions may be considered, and with an appropriate QoS flow definition applied to radar traffic.

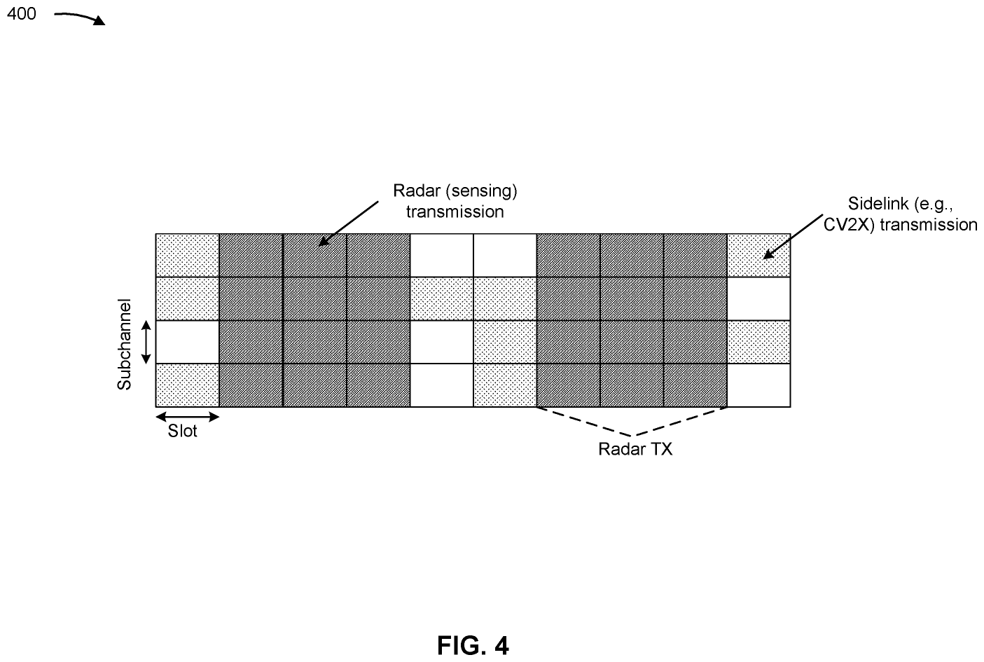

FIG. 4 is a diagram illustrating an example 400 of communication and radar transmissions in sidelink resources, in accordance with the present disclosure.

As shown in FIG. 4, a single sidelink resource pool may accommodate both sidelink transmissions (e.g., CV2X transmissions) and radar (or sensing) transmissions, which may originate from different UEs. Radar (or sensing) and sidelink transmissions may co-exist, such that the radar (or sensing) transmissions may occur over orthogonal resources as if they corresponded to the sidelink transmissions. The radar (or sensing) transmissions may have relatively large durations spanning multiple back-to-back slots and relatively bandwidth utilization that spans for more than one subchannel, as compared to sidelink transmissions that may occupy only a single slot and may have a variable bandwidth depending on a transport block size.

As indicated above, FIG. 4 is provided as an example. Other examples may differ from what is described with regard to FIG. 4.

For “sensing as a service” and a corresponding automotive use case, radar transmissions may co-exist with sidelink transmissions over same sidelink time-frequency resources. When using OFDM as a sensing/probing waveform, radar transmissions may be treated as additional traffic to actual sidelink traffic, and may be accommodated in a sidelink resource pool as such. However, with each radar transmission typically requiring a relatively large quantity of subchannels and multiple slots, a network load generated by the radar transmissions may be a multiple of a load generated by the sidelink transmissions. With a relatively large density of vehicles and radars per vehicle, performance degradation may be expected due to congestion, which may be due to collisions and interference effects.

With radars becoming a commodity in vehicles, operational conditions in which vehicles may perform both sidelink and radar (or sensing) transmissions within the same sidelink resource pool may be possible. With radar and sidelink (or data) transmissions both being triggered with roughly the same frequency (e.g., in the order of tens of milliseconds), each vehicle using multiple radars, and each radar transmission occupying a multiple of the resources that a typical sidelink transmission would occupy, radar transmissions may contribute a majority to a total sidelink network load. In some cases, a total sidelink and radar traffic may require more resources than available in a resource pool, which may lead to collisions or transmission drops even under network-assisted (sidelink mode 1) operation. For sidelink mode 2 (e.g., without network coverage), where collisions may be unavoidable even under moderate traffic loads, radar transmissions may inevitably increase a collision rate, which may degrade actual sidelink transmissions. In addition to the impact of collisions to sidelink transmissions, an increased collision rate may impact sensing performance since a sensing OFDM waveform may be sensitive to interference.

A different approach may be needed for accommodating sidelink and radar transmissions over a single sidelink resource pool that allows for more efficient multiplexing of transmissions, e.g., with reduced collision probabilities and interference levels, as compared to when treating radar transmissions as additional sidelink traffic.

In various aspects of techniques and apparatuses described herein, a UE may receive, from a network entity, a sidelink resource sub-pool configuration that indicates a partition of a sidelink resource pool into a first sidelink resource sub-pool associated with radar transmissions and a second sidelink resource sub-pool associated with sidelink transmissions. The UE may transmit a radar transmission using resources of the first sidelink resource sub-pool based at least in part on the sidelink resource sub-pool configuration.

In some aspects, the sidelink resource pool may be partitioned into the first sidelink resource sub-pool and the second sidelink resource sub-pool, where the first sidelink resource sub-pool may be dedicated for sidelink transmissions (or conventional transmissions) and the second sidelink resource sub-pool may be dedicated for radar transmissions. The sidelink resource pool may be partitioned into the first sidelink resource sub-pool and the second sidelink resource sub-pool based at least in part on frequency-modulated continuous wave (FMCW) waveforms being more robust to interference as compared to OFDM waveforms. When radar transmissions are performed using FMCW waveforms, a partitioning of the sidelink resource pool may allow for a more efficient multiplexing of radar transmissions over the same time-frequency resources, as compared to the strictly orthogonal resource allocation needed when the radar transmissions are treated as sidelink transmissions.

In some aspects, for automotive applications which may be associated with joint communication and radar/sensing operations, the sidelink resource pool may be adapted to efficiently accommodate multiplexed radar transmissions. The sidelink resource pool may be adapted by dedicating sidelink pool resources to radar transmissions, using FMCW waveforms for radar transmissions, and operating in a coordinated FMCW fashion. As a result, a more efficient resource utilization may be accomplished, as compared to treating radar TXs as an additional data traffic to be served via conventional sidelink transmissions. Such an adaptation of the sidelink resource pool may be beneficial in automotive scenarios with a relatively high density of vehicles and multiple radars per vehicle, especially in a mode-2 sidelink operation.

FIG. 5 is a diagram illustrating an example 500 associated with radar transmissions using resources of sidelink resource sub-pools, in accordance with the present disclosure. As shown in FIG. 5, example 500 includes communication between a UE (e.g., a first UE, such as UE 120a), a second UE (e.g., UE 120e), and a network entity (e.g., base station 110). In some aspects, the UE, the second UE, and the network entity may be included in a wireless network, such as wireless network 100.

As shown by reference number 502, the UE may receive (e.g., using antenna 252, modem 254, MIMO detector 256, receive processor 258, controller/processor 280, and/or memory 282), from the network entity, a sidelink resource sub-pool configuration that indicates a partition of a sidelink resource pool into a first sidelink resource sub-pool associated with radar transmissions and a second sidelink resource sub-pool associated with sidelink transmissions, such as CV2X transmissions. The sidelink resource pool may be partitioned into two sub-pools, where the first sidelink resource sub-pool may be exclusively utilized for radar transmissions and the second sidelink resource sub-pool may be exclusively utilized for sidelink transmissions.

In some aspects, the sidelink resource sub-pool configuration may include a bitmap that indicates the partition of the sidelink resource pool into the first sidelink resource sub-pool associated with radar transmissions and the second sidelink resource sub-pool associated with sidelink transmissions. The sidelink resource pool may be partitioned in time into the first sidelink resource sub-pool (e.g., a radar sub-pool associated with radar transmissions) and the second sidelink resource sub-pool (e.g., a CV2X sub-pool associated with CV2X transmissions). The sidelink resource pool may be partitioned in time based at least in part on the bitmap. For example, the bitmap may indicate {0, 1, 1, 1, 0, 0, 0, 0, 0, 0}, where a “1” may indicate a slot that is associated with the first sidelink resource sub-pool associated with radar transmissions. In this example, the bitmap may follow a size-10 pattern, which may be repeated for every set of 10 consecutive slots. Even though the first sidelink resource sub-pool may be determined based at least in part on slots, the notion of slots may be irrelevant for radar transmissions in the first sidelink resource sub-pool since the radar transmissions may occur arbitrarily within the first sidelink resource sub-pool.

In some aspects, the network entity may indicate the first sidelink resource sub-pool (e.g., the radar sub-pool associated with radar transmissions). The partition of the sidelink resource pool into the first sidelink resource sub-pool and the second sidelink resource sub-pool associated with sidelink transmissions may be based at least in part on a time division multiplexing (TDM) partitioning and/or a frequency division multiplexing (FDM) partitioning, where resources of the sidelink resource pool that are not included in the first sidelink resource sub-pool may be treated as sidelink resources. The TDM partitioning may be used, such that certain slots may be reserved only for FMCW radar transmissions that can span a whole sidelink allocated bandwidth. The network entity may indicate radar-reserved slots as a bitmap applied across resource pool slots (e.g., a “1” may correspond to a radar slot) that are repeated in time. The FDM partitioning may be used, such that certain subchannels over a plurality of sidelink slots (e.g., all sidelink slots) may be reserved for FMCW radar transmissions. The subchannels may be indicated as a bitmap, where the bitmap may be of a size equal to a quantity of resource pool subchannels with “1” identifying a radar subchannel. In some cases, TDM partitioning and FDM partitioning may be combined, such that radar transmissions may be performed only on specific slots and on specific subchannels within these slots. Further, resources that are not included in a first sidelink resource sub-pool configuration may be treated as sidelink resources.

In some aspects, the first sidelink resource sub-pool and/or the second sidelink resource sub-pool may be associated with a geographic region. In other words, sub-pool resources may be location dependent. In a first option, a set of sub-pool resources for a set of location/areas may be indicated so that the UE may switch to an appropriate configuration as the UE transitions from one area to another area. In a second option, the network entity may indicate an area identifier along with a sub-pool resource configuration. When the UE leaves an area corresponding to the area identifier, the UE may request the network entity to provide the sidelink resource sub-pool configuration for a new area entered by the UE.

In some aspects, the network entity may indicate bitmaps associated with the TDM partitioning and the FDM partitioning to the UE via RRC signaling, or the bitmaps may be pre-configured when the UE is out-of-coverage from the network entity.

In some aspects, the UE may receive the sidelink resource sub-pool configuration based at least in part on RRC signaling or a pre-configuration when the UE is out-of-coverage with the network entity. The UE may receive the sidelink resource sub-pool configuration based at least in part on periodic signaling from the network entity, or a request from the UE. Further, the sidelink resource sub-pool configuration may indicate a maximum transmit power limit for the radar transmission.

In some aspects, the sidelink resource sub-pool configuration (including the bitmaps) may be signaled from the network entity in a periodic manner using a pre-configured periodicity selected from a plurality of possible pre-configured periodicities. Signaling of the sidelink resource sub-pool configuration may be based at least in part on a broadcast type, a groupcast type, or a unicast type. In some aspects, the sidelink resource sub-pool configuration may be triggered by an RRC request from the UE, and the sidelink resource sub-pool configuration may be based at least in part on a unicast type. In some aspects, an indication of the sidelink resource sub-pool configuration, which may include a radar sub-pool indication signal, may also indicate the maximum transmission power limit. When the maximum transmission power limit is not indicated, the UE may perform radar transmissions using a pre-configured maximum power, or the UE may use the same maximum power as used for a sidelink resource pool. In some aspects, for a coordinated FMCW operation, the network entity may perform additional signaling to indicate an FMCW configuration to be followed by the UE.

In some aspects, the sidelink resource sub-pool configuration may be valid until a new sidelink resource sub-pool configuration is received or until a timer expires. The UE may assume that the sidelink resource sub-pool configuration indicating the first sidelink resource sub-pool (or a radar sub-pool configuration indication) is to be valid until the new sidelink resource sub-pool configuration is received or until the timer expires, wherein a timer duration may be (pre-)configured. When the UE is to perform a radar transmission but is unaware of a current sidelink resource sub-pool configuration (e.g., due to the UE moving outside of network coverage), the UE may perform the radar transmission as a conventional sidelink transmission or over resources that are estimated to be sidelink resources. In a first option, an estimation of the resources may be based at least in part on a UE implementation. For example, the UE may perform RSSI sensing and deduce a periodicity of an interval where a relatively strong RSSI is observed without any sidelink control information (SCI) decoded. In a second option, the UE may use a latest received pool configuration as an estimate of the resources. In a third option, the UE may use a pre-configured (or default) configuration as an estimate of the resources. Further, to overcome potential issues due to the estimation of the resources, the UE may request the sidelink resource sub-pool configuration indicating the first sidelink resource sub-pool directly from other UEs, for example, via a PC5 sidelink interface.

As shown by reference number 504, the UE may transmit (e.g., using controller/processor 280, transmit processor 264, TX MIMO processor 266, modem 254, antenna 252, and/or memory 282), to the second UE, a radar transmission using resources of the first sidelink resource sub-pool based at least in part on the sidelink resource sub-pool configuration. The UE may transmit the radar transmission using resources of the first sidelink resource sub-pool based at least in part on a FMCW waveform.

In some aspects, radar transmissions over radar-reserved sidelink resources associated with the first sidelink resource sub-pool may be performed using FMCW waveforms instead of OFDM waveforms. Multi-radar operation with FMCW waveforms may be more robust to interference as compared to OFDM waveforms. For example, a sensing performance of two or more radars transmitting over same time-frequency resources may be better (e.g., more robust to interference) when FMCW waveforms are employed instead of OFDM waveforms are employed. In addition to being more robust to interference, FMCW waveform based sensing may eliminate the need to reserve resources and an alignment of radar transmissions to sidelink resource pool slot boundaries, such that a UE may be able to perform sensing at an arbitrary instant without transmitting signaling to other UEs.

In some aspects, the UE may transmit multiple coordinated radar transmissions using the resources of the first sidelink resource sub-pool based at least in part on common FMCW waveform parameters indicated in the sidelink resource sub-pool configuration. FMCW transmissions within the first sidelink resource sub-pool utilized for radar transmissions may be coordinated, and may be based at least in part on a common configuration identified and indicated by the network entity. An uncoordinated multi-radar FMCW operation may be affected by interference when a radar density satisfies a threshold, but a coordinated multi-radar FMCW operation may be applied to accommodate a larger quantity of FMCW transmissions over same sidelink resources.

In some aspects, the UE may transmit, to the network entity, feedback that indicates radar activity, sidelink activity (e.g., CV2X activity), network load measurements, and/or a location identifier associated with the UE. The network entity may adapt the network first sidelink resource sub-pool and the second sidelink resource sub-pool based at least in part on the feedback.

In some aspects, under low radar activity (e.g., low vehicle density), a fixed resource partitioning may be inefficient. For example, infrequent radar transmissions may be accommodated within the sidelink resource pool without unnecessarily restricting resources for sidelink transmissions. The first sidelink resource sub-pool (e.g., radar sub-pool resources) may be adapted according to current sidelink and radar traffic loads.

In some aspects, the UE may transmit the feedback to the network entity for first sidelink resource sub-pool (or radar sub-pool) resource adaptation purposes. The feedback may indicate the radar activity, which may indicate a quantity of sidelink resources to be required by a plurality of radar transmissions (e.g., all radar transmissions) within a pre-configured time interval (or window) if the plurality of radar transmissions were to be transmitted as sidelink transmissions. The radar activity may indicate high-level radar transmission parameters, such as bandwidth, a coherent processing interval, and/or a sensing rate (or period). The radar activity may indicate radar application requirements (e.g., a maximum detection range, and/or a detection accuracy/resolution). The feedback may indicate the sidelink activity (e.g., a channel occupancy ratio (CR) measurement). The feedback may indicate an experienced network load over currently assigned sidelink resources, such as a channel busy ratio (CBR). The feedback may indicate the location identifier of the UE, such as a zone identifier, which may aid a location-based radar sub-pool configuration. In some aspects, the UE may transmit the feedback to the network entity periodically according to a (pre-)configured period, or the UE may transmit the feedback upon a request by the network via RRC signaling.

As indicated above, FIG. 5 is provided as an example. Other examples may differ from what is described with regard to FIG. 5.

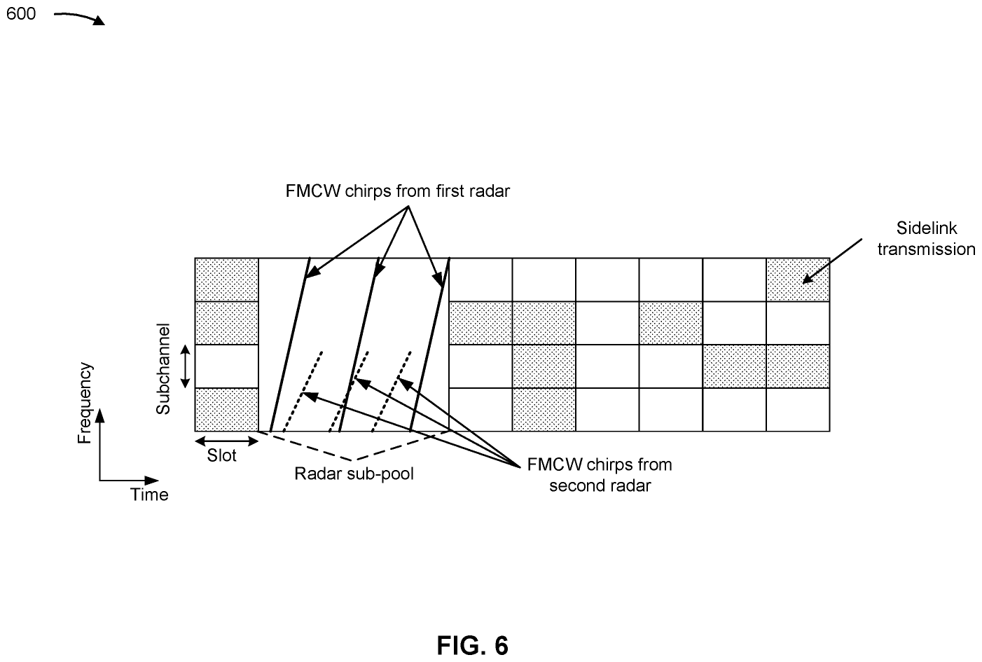

FIG. 6 is a diagram illustrating an example 600 associated with radar transmissions using resources of sidelink resource sub-pools, in accordance with the present disclosure.

As shown in FIG. 6, in a first sidelink resource sub-pool (e.g., a radar sub-pool associated with radar transmissions), two FMCW transmissions may be performed using same resources. A first FMCW transmission may be associated with FMCW chirps from a first radar, and a second FMCW transmission may be associated with FMCW chirps from a second radar. The first FMCW transmission and the second first FMCW transmission may be associated with FMCW waveforms that increase in frequency over time. The first FMCW transmission and the second first FMCW transmission may be uncoordinated, such that the FMCW chirps from the first radar may be transmitted having different parameters (e.g., bandwidth sweep, duration, and/or periodicity) than the FMCW chirps from the second radar. By performing the two FMCW transmissions over the same resources, required resources for radar transmissions may be reduced by half, as compared to when the radar transmissions are treated as additional sidelink traffic.

As indicated above, FIG. 6 is provided as an example. Other examples may differ from what is described with regard to FIG. 6.

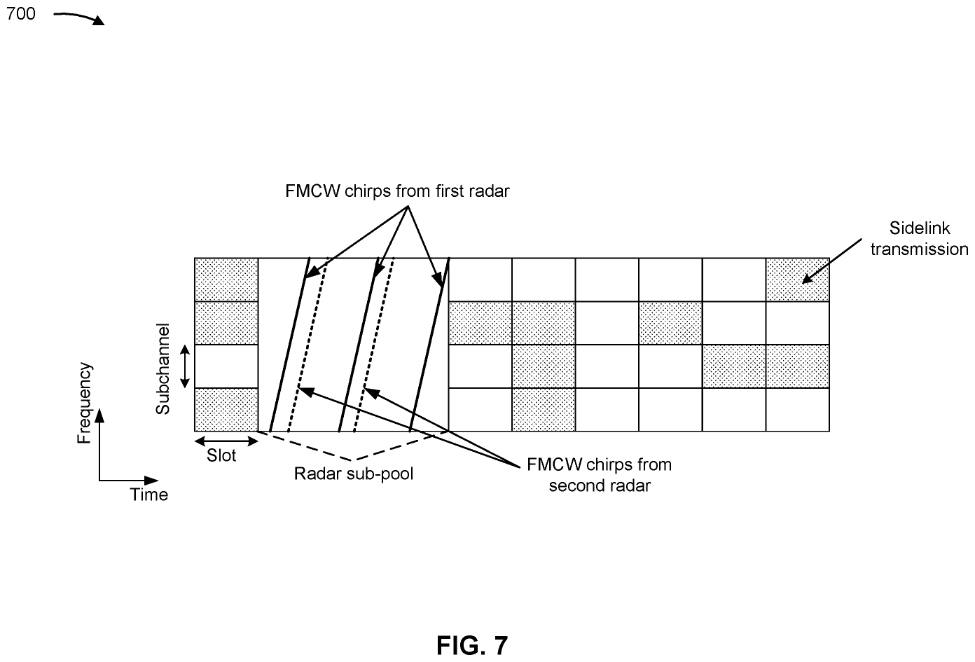

FIG. 7 is a diagram illustrating an example 700 associated with radar transmissions using resources of sidelink resource sub-pools, in accordance with the present disclosure.

As shown in FIG. 7, in a first sidelink resource sub-pool (e.g., a radar sub-pool associated with radar transmissions), two FMCW transmissions may be performed using same resources. A first FMCW transmission may be associated with FMCW chirps from a first radar, and a second FMCW transmission may be associated with FMCW chirps from a second radar. The first FMCW transmission and the second first FMCW transmission may be associated with FMCW waveforms that increase in frequency over time. The first FMCW transmission and the second first FMCW transmission may be coordinated, such that the FMCW chirps from the first radar may be transmitted having same parameters (e.g., bandwidth sweep, duration, and/or periodicity) than the FMCW chirps from the second radar. The first radar and the second radar may transmit using a common FMCW waveform or configuration (e.g., a common chirp bandwidth, duration, and/or periodicity).

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with radar transmissions using resources of sidelink resource sub-pools.

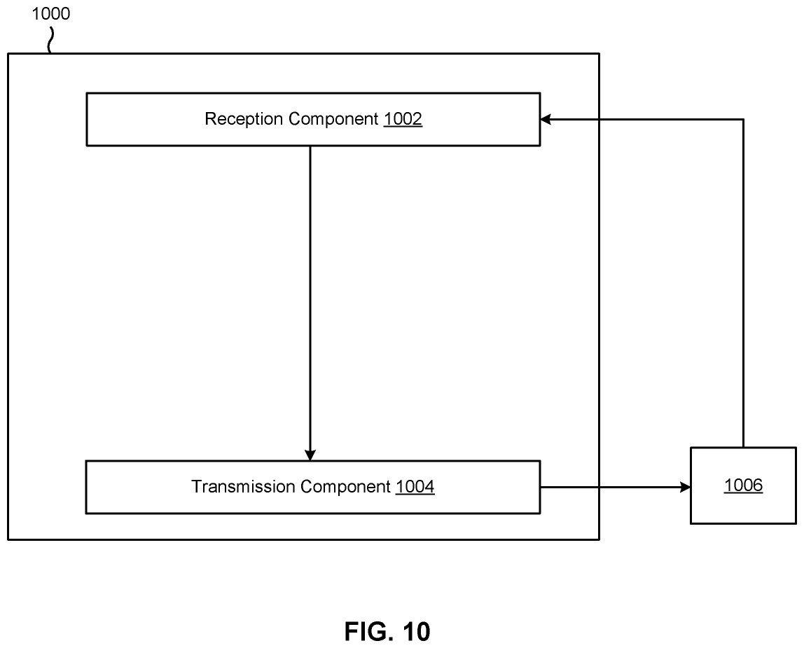

As shown in FIG. 8, in some aspects, process 800 may include receiving, from a network entity, a sidelink resource sub-pool configuration that indicates a partition of a sidelink resource pool into a first sidelink resource sub-pool associated with radar transmissions and a second sidelink resource sub-pool associated with sidelink transmissions (block 810). For example, the UE (e.g., using reception component 1002, depicted in FIG. 10) may receive, from a network entity, a sidelink resource sub-pool configuration that indicates a partition of a sidelink resource pool into a first sidelink resource sub-pool associated with radar transmissions and a second sidelink resource sub-pool associated with sidelink transmissions, as described above with reference to FIGS. 5-7.

As further shown in FIG. 8, in some aspects, process 800 may include transmitting a radar transmission using resources of the first sidelink resource sub-pool based at least in part on the sidelink resource sub-pool configuration (block 820). For example, the UE (e.g., using transmission component 1004, depicted in FIG. 10) may transmit a radar transmission using resources of the first sidelink resource sub-pool based at least in part on the sidelink resource sub-pool configuration, as described above with reference to FIGS. 5-7.

Process 800 may include additional aspects, such as any single aspect or any combination of aspects described below and/or in connection with one or more other processes described elsewhere herein.

In a first aspect, process 800 includes transmitting the radar transmission using resources of the first sidelink resource sub-pool based at least in part on a frequency-modulated continuous wave waveform. In a second aspect, alone or in combination with the first aspect, process 800 includes transmitting multiple coordinated radar transmissions using the resources of the first sidelink resource sub-pool based at least in part on common frequency-modulated continuous wave waveform parameters indicated in the sidelink resource sub-pool configuration.

In a third aspect, alone or in combination with one or more of the first and second aspects, the sidelink resource sub-pool configuration includes a bitmap that indicates the partition of the sidelink resource pool into the first sidelink resource sub-pool associated with radar transmissions and the second sidelink resource sub-pool associated with sidelink transmissions. In a fourth aspect, alone or in combination with one or more of the first through third aspects, the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and resources of the sidelink resource pool that are not included in the first sidelink resource sub-pool are treated as sidelink resources.

In a fifth aspect, alone or in combination with one or more of the first through fourth aspects, one or more of the first sidelink resource sub-pool or the second sidelink resource sub-pool are associated with a geographic region. In a sixth aspect, alone or in combination with one or more of the first through fifth aspects, process 800 includes receiving the sidelink resource sub-pool configuration based at least in part on: a radio resource control signaling, or a pre-configuration based at least in part on the UE being out-of-coverage with the network entity. In a seventh aspect, alone or in combination with one or more of the first through sixth aspects, process 800 includes receiving the sidelink resource sub-pool configuration based at least in part on periodic signaling from the network entity, or a request from the UE.

In an eighth aspect, alone or in combination with one or more of the first through seventh aspects, the sidelink resource sub-pool configuration indicates a maximum transmit power limit for the radar transmission. In a ninth aspect, alone or in combination with one or more of the first through eighth aspects, process 800 includes transmitting, to the network entity, feedback that indicates one or more of radar activity, sidelink activity, network load measurements, or a location identifier associated with the UE, wherein the first sidelink resource sub-pool and the second sidelink resource sub-pool are adapted based at least in part on the feedback. In a tenth aspect, alone or in combination with one or more of the first through ninth aspects, the sidelink resource sub-pool configuration is valid until a new sidelink resource sub-pool configuration is received or until a timer expires.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., base station 110) performs operations associated with radar transmissions using resources of sidelink resource sub-pools.

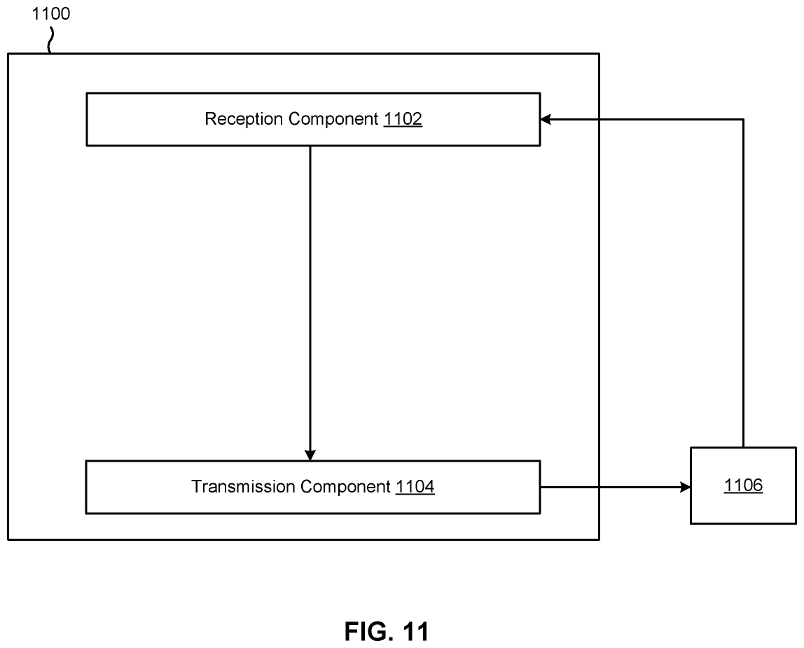

As shown in FIG. 9, in some aspects, process 900 may include transmitting, to a UE, a sidelink resource sub-pool configuration that indicates a partition of a sidelink resource pool into a first sidelink resource sub-pool associated with radar transmissions and a second sidelink resource sub-pool associated with sidelink transmissions (block 910). For example, the network entity (e.g., using transmission component 1104, depicted in FIG. 11) may transmit, to a UE, a sidelink resource sub-pool configuration that indicates a partition of a sidelink resource pool into a first sidelink resource sub-pool associated with radar transmissions and a second sidelink resource sub-pool associated with sidelink transmissions, as described above with reference to FIGS. 5-7.

Process 900 may include additional aspects, such as any single aspect or any combination of aspects described below and/or in connection with one or more other processes described elsewhere herein.

In a first aspect, the sidelink resource sub-pool configuration includes a bitmap that indicates the partition of the sidelink resource pool into the first sidelink resource sub-pool associated with radar transmissions and the second sidelink resource sub-pool associated with sidelink transmissions. In a second aspect, alone or in combination with the first aspect, the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and wherein resources of the sidelink resource pool that are not included in the first sidelink resource sub-pool are treated as sidelink resources. In a third aspect, alone or in combination with one or more of the first and second aspects, process 900 includes receiving, from the UE, feedback that indicates one or more of radar activity, sidelink activity, network load measurements, or a location identifier associated with the UE; and adapting the first sidelink resource sub-pool and the second sidelink resource sub-pool based at least in part on the feedback.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network entity, a sidelink resource sub-pool configuration that indicates a partition of a sidelink resource pool into a first sidelink resource sub-pool associated with radar transmissions and a second sidelink resource sub-pool associated with sidelink transmissions. The transmission component 1004 may transmit a radar transmission using resources of the first sidelink resource sub-pool based at least in part on the sidelink resource sub-pool configuration.

The transmission component 1004 may transmit, to the network entity, feedback that indicates one or more of: radar activity, sidelink activity, network load measurements, or a location identifier associated with the UE, wherein the first sidelink resource sub-pool and the second sidelink resource sub-pool are adapted based at least in part on the feedback.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network entity, or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The transmission component 1104 may transmit, to a UE, a sidelink resource sub-pool configuration that indicates a partition of a sidelink resource pool into a first sidelink resource sub-pool associated with radar transmissions and a second sidelink resource sub-pool associated with sidelink transmissions.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a network entity, a sidelink resource sub-pool configuration that indicates a partition of a sidelink resource pool into a first sidelink resource sub-pool associated with radar transmissions and a second sidelink resource sub-pool associated with sidelink transmissions; and transmitting a radar transmission using resources of the first sidelink resource sub-pool based at least in part on the sidelink resource sub-pool configuration.

Aspect 2: The method of Aspect 1, wherein transmitting the radar transmission using resources of the first sidelink resource sub-pool is based at least in part on a frequency-modulated continuous wave waveform.

Aspect 3: The method of any of Aspects 1 through 2, wherein transmitting the radar transmission comprises transmitting multiple coordinated radar transmissions using the resources of the first sidelink resource sub-pool based at least in part on common frequency-modulated continuous wave waveform parameters indicated in the sidelink resource sub-pool configuration.

Aspect 4: The method of any of Aspects 1 through 3, wherein the sidelink resource sub-pool configuration includes a bitmap that indicates the partition of the sidelink resource pool into the first sidelink resource sub-pool associated with radar transmissions and the second sidelink resource sub-pool associated with sidelink transmissions.

Aspect 5: The method of any of Aspects 1 through 4, wherein the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and wherein resources of the sidelink resource pool that are not included in the first sidelink resource sub-pool are treated as sidelink resources.

Aspect 6: The method of any of Aspects 1 through 5, wherein one or more of the first sidelink resource sub-pool or the second sidelink resource sub-pool are associated with a geographic region.

Aspect 7: The method of any of Aspects 1 through 6, wherein receiving the sidelink resource sub-pool configuration is based at least in part on: a radio resource control signaling, or a pre-configuration based at least in part on the UE being out-of-coverage with the network entity.

Aspect 8: The method of any of Aspects 1 through 7, wherein receiving the sidelink resource sub-pool configuration is based at least in part on: periodic signaling from the network entity, or a request from the UE.

Aspect 9: The method of any of Aspects 1 through 8, wherein the sidelink resource sub-pool configuration indicates a maximum transmit power limit for the radar transmission.

Aspect 10: The method of any of Aspects 1 through 9, further comprising: transmitting, to the network entity, feedback that indicates one or more of: radar activity, sidelink activity, network load measurements, or a location identifier associated with the UE, wherein the first sidelink resource sub-pool and the second sidelink resource sub-pool are adapted based at least in part on the feedback.

Aspect 11: The method of any of Aspects 1 through 10, wherein the sidelink resource sub-pool configuration is valid until a new sidelink resource sub-pool configuration is received or until a timer expires.

Aspect 12: A method of wireless communication performed by a network entity, comprising: transmitting, to a user equipment (UE), a sidelink resource sub-pool configuration that indicates a partition of a sidelink resource pool into a first sidelink resource sub-pool associated with radar transmissions and a second sidelink resource sub-pool associated with sidelink transmissions.

Aspect 13: The method of Aspect 12, wherein the sidelink resource sub-pool configuration includes a bitmap that indicates the partition of the sidelink resource pool into the first sidelink resource sub-pool associated with radar transmissions and the second sidelink resource sub-pool associated with sidelink transmissions.

Aspect 14: The method of any of Aspects 12 through 13, wherein the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and wherein resources of the sidelink resource pool that are not included in the first sidelink resource sub-pool are treated as sidelink resources.

Aspect 15: The method of any of Aspects 12 through 14, further comprising: receiving, from the UE, feedback that indicates one or more of: radar activity, sidelink activity, network load measurements, or a location identifier associated with the UE; and adapting the first sidelink resource sub-pool and the second sidelink resource sub-pool based at least in part on the feedback.

Aspect 16: An apparatus for wireless communication at a device, comprising a processor; memory coupled with the processor; and instructions stored in the memory and executable by the processor to cause the apparatus to perform the method of one or more of Aspects 1-11.

Aspect 17: A device for wireless communication, comprising a memory and one or more processors coupled to the memory, the one or more processors configured to perform the method of one or more of Aspects 1-11.

Aspect 18: An apparatus for wireless communication, comprising at least one means for performing the method of one or more of Aspects 1-11.

Aspect 19: A non-transitory computer-readable medium storing code for wireless communication, the code comprising instructions executable by a processor to perform the method of one or more of Aspects 1-11.

Aspect 20: A non-transitory computer-readable medium storing a set of instructions for wireless communication, the set of instructions comprising one or more instructions that, when executed by one or more processors of a device, cause the device to perform the method of one or more of Aspects 1-11.

Aspect 21: An apparatus for wireless communication at a device, comprising a processor; memory coupled with the processor; and instructions stored in the memory and executable by the processor to cause the apparatus to perform the method of one or more of Aspects 12-15.

Aspect 22: A device for wireless communication, comprising a memory and one or more processors coupled to the memory, the one or more processors configured to perform the method of one or more of Aspects 12-15.

Aspect 23: An apparatus for wireless communication, comprising at least one means for performing the method of one or more of Aspects 12-15.

Aspect 24: A non-transitory computer-readable medium storing code for wireless communication, the code comprising instructions executable by a processor to perform the method of one or more of Aspects 12-15.

Aspect 25: A non-transitory computer-readable medium storing a set of instructions for wireless communication, the set of instructions comprising one or more instructions that, when executed by one or more processors of a device, cause the device to perform the method of one or more of Aspects 12-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network entity, a sidelink resource sub-pool configuration that indicates a partition of a sidelink resource pool into a first sidelink resource sub-pool associated with radar transmissions and a second sidelink resource sub-pool associated with sidelink transmissions; and
transmit a radar transmission using resources of the first sidelink resource sub-pool based at least in part on the sidelink resource sub-pool configuration.

2. The apparatus of claim 1, wherein the one or more processors are configured to transmit the radar transmission using resources of the first sidelink resource sub-pool based at least in part on a frequency-modulated continuous wave waveform.

3. The apparatus of claim 1, wherein the one or more processors are configured to transmit multiple coordinated radar transmissions using the resources of the first sidelink resource sub-pool based at least in part on common frequency-modulated continuous wave waveform parameters indicated in the sidelink resource sub-pool configuration.

4. The apparatus of claim 1, wherein the sidelink resource sub-pool configuration includes a bitmap that indicates the partition of the sidelink resource pool into the first sidelink resource sub-pool associated with radar transmissions and the second sidelink resource sub-pool associated with sidelink transmissions.

5. The apparatus of claim 1, wherein the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and wherein resources of the sidelink resource pool that are not included in the first sidelink resource sub-pool are treated as sidelink resources.

6. The apparatus of claim 1, wherein one or more of the first sidelink resource sub-pool or the second sidelink resource sub-pool are associated with a geographic region.

7. The apparatus of claim 1, wherein the one or more processors are configured to receive the sidelink resource sub-pool configuration based at least in part on: a radio resource control signaling, or a pre-configuration based at least in part on the UE being out-of-coverage with the network entity.

8. The apparatus of claim 1, wherein the one or more processors are configured to receive the sidelink resource sub-pool configuration based at least in part on: periodic signaling from the network entity, or a request from the UE.

9. The apparatus of claim 1, wherein the sidelink resource sub-pool configuration indicates a maximum transmit power limit for the radar transmission.

10. The apparatus of claim 1, wherein the one or more processors are further configured to:
transmit, to the network entity, feedback that indicates one or more of: radar activity, sidelink activity, network load measurements, or a location identifier associated with the UE, wherein the first sidelink resource sub-pool and the second sidelink resource sub-pool are adapted based at least in part on the feedback.

11. The apparatus of claim 1, wherein the sidelink resource sub-pool configuration is valid until a new sidelink resource sub-pool configuration is received or until a timer expires.

12. An apparatus for wireless communication at a network entity, comprising:
a memory; and
one or more processors, coupled to the memory, configured to:
transmit, to a user equipment (UE), a sidelink resource sub-pool configuration that indicates a partition of a sidelink resource pool into a first sidelink resource sub-pool associated with radar transmissions and a second sidelink resource sub-pool associated with sidelink transmissions.

13. The apparatus of claim 12, wherein the sidelink resource sub-pool configuration includes a bitmap that indicates the partition of the sidelink resource pool into the first sidelink resource sub-pool associated with radar transmissions and the second sidelink resource sub-pool associated with sidelink transmissions.

14. The apparatus of claim 12, wherein the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and wherein resources of the sidelink resource pool that are not included in the first sidelink resource sub-pool are treated as sidelink resources.

15. The apparatus of claim 12, wherein the one or more processors are further configured to:
receive, from the UE, feedback that indicates one or more of: radar activity, sidelink activity, network load measurements, or a location identifier associated with the UE; and
adapt the first sidelink resource sub-pool and the second sidelink resource sub-pool based at least in part on the feedback.

16. A method of wireless communication performed by a user equipment (UE), comprising:
receiving, from a network entity, a sidelink resource sub-pool configuration that indicates a partition of a sidelink resource pool into a first sidelink resource sub-pool associated with radar transmissions and a second sidelink resource sub-pool associated with sidelink transmissions; and
transmitting a radar transmission using resources of the first sidelink resource sub-pool based at least in part on the sidelink resource sub-pool configuration.

17. The method of claim 16, wherein transmitting the radar transmission using resources of the first sidelink resource sub-pool is based at least in part on a frequency-modulated continuous wave waveform.

18. The method of claim 16, wherein transmitting the radar transmission comprises transmitting multiple coordinated radar transmissions using the resources of the first sidelink resource sub-pool based at least in part on common frequency-modulated continuous wave waveform parameters indicated in the sidelink resource sub-pool configuration.

19. The method of claim 16, wherein the sidelink resource sub-pool configuration includes a bitmap that indicates the partition of the sidelink resource pool into the first sidelink resource sub-pool associated with radar transmissions and the second sidelink resource sub-pool associated with sidelink transmissions.

20. The method of claim 16, wherein the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and wherein resources of the sidelink resource pool that are not included in the first sidelink resource sub-pool are treated as sidelink resources.

21. The method of claim 16, wherein one or more of the first sidelink resource sub-pool or the second sidelink resource sub-pool are associated with a geographic region.

22. The method of claim 16, wherein receiving the sidelink resource sub-pool configuration is based at least in part on a radio resource control signaling or a pre-configuration when the UE is out-of-coverage with the network entity.

23. The method of claim 16, wherein receiving the sidelink resource sub-pool configuration is based at least in part on: periodic signaling from the network entity, or a request from the UE.

24. The method of claim 16, wherein the sidelink resource sub-pool configuration indicates a maximum transmit power limit for the radar transmission.

25. The method of claim 16, further comprising:
transmitting, to the network entity, feedback that indicates one or more of: radar activity, sidelink activity, network load measurements, or a location identifier associated with the UE, wherein the first sidelink resource sub-pool and the second sidelink resource sub-pool are adapted based at least in part on the feedback.

26. The method of claim 16, wherein the sidelink resource sub-pool configuration is valid until a new sidelink resource sub-pool configuration is received or until a timer expires.

27. A method of wireless communication performed by a network entity, comprising:
transmitting, to a user equipment (UE), a sidelink resource sub-pool configuration that indicates a partition of a sidelink resource pool into a first sidelink resource sub-pool associated with radar transmissions and a second sidelink resource sub-pool associated with sidelink transmissions.

28. The method of claim 27, wherein the sidelink resource sub-pool configuration includes a bitmap that indicates the partition of the sidelink resource pool into the first sidelink resource sub-pool associated with radar transmissions and the second sidelink resource sub-pool associated with sidelink transmissions.

29. The method of claim 27, wherein the partition of the sidelink resource pool into the first sidelink resource sub-pool and the second sidelink resource sub-pool associated with sidelink transmissions is based at least in part on one or more of a time division multiplexing partitioning or a frequency division multiplexing partitioning, and wherein resources of the sidelink resource pool that are not included in the first sidelink resource sub-pool are treated as sidelink resources.

30. The method of claim 27, further comprising:
receiving, from the UE, feedback that indicates one or more of: radar activity, sidelink activity, network load measurements, or a location identifier associated with the UE; and
adapting the first sidelink resource sub-pool and the second sidelink resource sub-pool based at least in part on the feedback.
